(19) United States
(12) Patent Application Publication
(10) Pub. No.: US 2023/0420664 A1
(43) Pub. Date: Dec. 28, 2023

(54) DOPED SILICON ANODE FOR LITHIUM-ION BATTERIES

(71) Applicant: Posi Energy- Silicon Power. LLC, Pleasantville, NY (US)

(72) Inventors: Devendra K. Sadana, Pleasantville, NY (US); Joel P. De Souza, Putnam Valley, NY (US); Brian Williams, Hillsborough, NJ (US); Francis Christopher Farmer, Cherry Hill, NJ (US)

(73) Assignee: Posi Energy- Silicon Power. LLC, Pleasantville, NY (US)

(21) Appl. No.: 17/952,226

(22) Filed: Sep. 24, 2022

Related U.S. Application Data
(60) Provisional application No. 63/355,855, filed on Jun. 27, 2022.

(51) Int. Cl. H01M 4/38; H01M 10/0525; H01M 4/04

(52) U.S. Cl. CPC H01M 4/386; H01M 10/0525; H01M 4/382; H01M 4/0416; H01M 2004/027

(57) ABSTRACT

An element to be used as an anode in a lithium-ion battery comprising an electrochemically lithiated thick or thin p or n-doped virgin single crystal Si with or without an oxide on the upper surface thereof. The lithiated structure further has a plurality of single crystalline p or n-doped Si particles dispersed over a non-lithium reactive reacting electrically conductive adhesive positioned atop a current collector.

### FIELD OF THE INVENTION

The present invention relates to lithium-ion batteries (LIB), and more particularly, within said batteries, to a novel, high-performance, long-life Si anode via electrochemical lithiation of single crystal p or n-doped single crystal Si.

### BACKGROUND OF THE INVENTION

Lithium batteries can charge and discharge many times, are generally stable, and have high energy densities per weight and volume.

In some embodiments, anodes in lithium-ion batteries are made from silicon (Si), specifically a silicon powder that has small crystalline or polycrystalline silicon particles in random orientations packed together with graphite powder. There are voids/spaces among these particles. Lithium is stored within the silicon and graphite particles (which have a high absorption for the lithium) and in the voids/spaces. Silicon possesses a high specific capacity of 4200 mAh/g (corresponding to LiSi), which is more than 10 times that of commercially used graphite (372 mAh/g). When silicon is used as an anode material and is exposed to a lithiation process by which lithium is incorporated into the silicon anode, there is a volume expansion of about 300%, which causes cracking and pulverization of the Si anode during charge/discharge cycling, resulting in the loss of mechanical/electrical contact and subsequent capacity fading.

As batteries get older and efficiency decreases, they enter a “capacity fade,” which occurs when the amount of charge a battery could once hold, begins to decrease with repeated use. The capacity of a lithium-ion battery directly correlates to the amount of lithium ions that can be shuttled back and forth as the device is charged and discharged. As the functioning battery is cycled, some of those lithium ions get stripped out of the cathode material and end up at the battery's anode.

In some embodiments, the prior art uses thick single crystal silicon substrates that are porous.

The pores in the single crystal silicon substrates have open spaces between them which can allow expansion and contraction of Si during charge and discharge cycling.

These types of porous silicon substrate can form nanowire-type lithiated silicon structures within the single crystal silicon substrate. Accordingly, while increasing lithium storage per silicon substrate volumes (due to the increased porous surface area exposed to lithium), these silicon substrates increase the amount of lithium intercalation and result in structural failures of these substrates.

To store large amounts of lithium and improve the energy density of these batteries (e.g., both in micro-batteries and larger batteries, like power cells), the cathode material requires high loading, typically greater than 15 mg/cm². The high loading of these cathodes provides a larger amount of lithium for storage in the battery anode.

During a discharge cycle, when the battery is connected to an external circuit load, electrons flow from the anode through the circuit load and back to the cathode. Generally, the lithium metal atoms diffused in and/or in contact with the anode, lose an electron and become lithium ions in, on, or near the anode and silicon substrate. These lithium ions then move through the battery, e.g., through the battery electrolyte, creating an (lithium ion) ionic current. Reaching the cathode, lithium ions intercalate into the cathode lattice and are reduced by electrons provided from the load circuit.

During a charging cycle, the ionic current reverses in the battery. A charging power source removes electrons from the lithium compounds at the cathode to create lithium ions at/in the cathode region. In the charging cycle, these lithium ions migrate through the electrolyte as lithium ionic current back to the anode and accumulate at anode surface or intercalate in the anode lattice where they become reduced by the electrons provided by the charging power source.

The accumulation of lithium metal at the anode and electrochemical processes within the battery causes a potential difference across the battery between the anode and cathode that enables the battery to produce a current through an external load during the next discharge cycle.

Lithium is absorbed or intercalated at a high concentration in these prior art anode substrates, e.g., silicon substrates. This intercalation (reversible inclusion or insertion of a molecule or ion into a material layer) creates large volume changes in the silicon substrate during the charge and discharge cycles.

These volume changes cause battery failure due to silicon substrate cracking, battery leakage of internal components, contaminants entering the battery, internal shorting of battery components, etc.

Other failure modes include lithium dendrite growth into and from the substrate which also causes component shorting, substrate weakening, cracking, contamination, battery leakage, etc.

More specifically, with respect to the present invention, there are a number of patents and publications in the prior art that are directed specifically to Li-ion batteries that contain a Si anode. These patents disclose the structure of a porous-Si anode, including porous-Si anode with a solid state (polymer) electrolyte; porous-Si anode used in microbattery structures; and a publication disclosing a porous-Si anode with catholytes. There are also methods disclosed for forming said porous-Si anode, e.g., using a RCA clean as a pre-requisite. There are porous-Si anodes that are used in a fast charge rate (low capacity) battery containing a ceramic electrolyte (LiPON).

The porous-Si anode structure defined in one prior art reference is severely limited in scope. It has a specific two-layer structure with a very top layer (<100 nm or so) with low porosity (<30%) as the nucleation layer for Li plating and a higher porosity 2nd layer beneath the top low porosity layer. It specifically avoids using any porosity >30% to damage the Si anode during the battery cycling.

The features of significance in obtaining an efficient Si-porous anode are lithiation and the Si-porous anode doping level and resistivity. Although electrochemical lithiation has been practiced in the prior art, its application was limited to porous-Si of low porosity (<40/).

In one prior art reference, only the doping level of Boron is mentioned (˜10¹⁹ cm³). Although 10¹⁹ cm³ doping level should typically give Si resistivity of 0.005 ohm·cm, but that is not guaranteed. It depends on the crystal quality. Therefore, a doping level without a specific resistivity value can be challenged. The porous-Si in some prior art used resistivity >0.01 ohm·cm. This higher level of resistivity can cause a high internal resistance in the battery and degrade its performance.

### BRIEF SUMMARY OF THE INVENTION

In addressing the above-mentioned deficiencies found in the prior art, it has been discovered that electrochemical lithiation of prime or virgin single crystal p-doped Si with a chemical oxide provides the same high performance as that with a lithiated porous-Si layer. The key parameters enabling this remarkable behavior are—low resistivity of the Si and its electrochemical lithiation. This invention can enable roll-to-roll implementation of the Si anode by using p-doped or n-doped single crystal Si particles, spraying them over a calendared conducting slurry or other conducting medium that allows strong adhesion of the single crystal Si particles to the slurry and maintains high conductivity among the Si particles, and subsequently lithiating the formed product.

### BRIEF DESCRIPTION OF THE DRAWINGS

Various embodiments of the present invention will be described below in more detail, with reference to the accompanying drawings, now briefly described. The Figures show various apparatus, structures, devices, and related method embodiments of the present invention and invention uses.

FIG. 1 is a cross sectional view of a single crystal single crystal p or n-doped element adapted to form an anode used in a Li-ion battery, that contains no surface oxide thereon.

FIG. 2 is a cross sectional view of a single crystal single crystal p or n-doped element adapted to form an anode used in a Li-ion battery, that contains an uneven, native SiO₂ surface oxide thereon.

FIG. 3 is a cross sectional view of a single crystal p or n-doped element adapted to form an anode used in a Li-ion battery, that contains a uniform SiO₂ surface layer covering its upper surface.

FIG. 4 is a cross sectional view of a single crystal p or n-doped element adapted to form an anode used in a Li-ion battery, that contains a leaky SiO₂ surface layer covering its upper surface.

FIG. 5 is a cross sectional view of a single crystal p or n-doped element adapted to form an anode used in a Li-ion battery, that contains a porous Si surface layer covering its upper surface.

FIG. 6 is a cross sectional view of a Li-ion half-cell structure depicting any of the surface layers depicted in FIGS. 1-5 above, interspersed between a Li metal electrode atop a combination of a separator and a liquid electrolyte and a single crystal p or n-doped electrode atop a current collector.

FIG. 7 is a cross sectional view of a Si anode after electrochemical lithiation of the surface structures depicted in FIG. 6.

FIG. 8 is a cross sectional view of a single crystal p or n-doped element adapted to form an anode used in a Li-ion battery, that contains a thin layer of p or n-doped Si atop a seed layer (to provide ohmic contact to the current collector [symbol] atop a current collector and having no surface oxide on the p or n-doped Si.

FIG. 9 is a cross sectional view of a single crystal p or n-doped element adapted to form an anode used in a Li-ion battery, that contains a thin layer of single crystal p or n-doped Si atop a seed layer (to provide ohmic contact to the current collector deposited over it) atop a current collector and having an uneven native SiO₂ surface oxide on the single crystal p or n-doped layer.

FIG. 10 is a cross sectional view of a single crystal p or n-doped element adapted to form an anode used in a Li-ion battery, that contains a thin layer of p or n-doped Si atop a seed layer (to provide ohmic contact to the current collector deposited over it) atop a current collector and having a uniform SiO₂ surface oxide on the single crystal p or n-doped layer.

FIG. 11 is a cross sectional view of a single crystal p or n-doped element adapted to form an anode used in a Li-ion battery, that contains a thin layer of single crystal p or n-doped Si atop a seed layer (to provide ohmic contact to the current collector deposited over it) atop a current collector and having a leaky SiO₂ surface oxide on the single crystal p or n-doped layer.

FIG. 12 is a cross sectional view of a single crystal p or n-doped element adapted to form an anode used a Li-ion battery, that contains a thin layer of p or n-doped Si atop a seed layer (to provide ohmic contact to the current collector deposited over it) atop a current collector and having a porous Si surface on the single crystal p-type doped Si layer.

FIG. 13 is a cross sectional view of a Li-ion half-cell depicting any of the surface layers depicted in FIGS. 1-5 above, interspersed between a Li metal electrode atop a combination of a separator and a liquid electrolyte and a thin single crystal p or n-doped electrode atop a seed layer (to provide ohmic contact to the current collector deposited over it) atop a current collector.

FIG. 14 is a cross sectional view of the Si anode structure resulting after an electrochemical lithiation of the structure depicted in FIG. 13.

FIG. 15 is a cross sectional view of single crystal p or n-doped particles having the structures depicted in FIG. 1-5 above atop a conductive carbon mixed with a strong adhesive and organic components atop a metal sheet current collector.

FIG. 16 is a cross sectional view of a Li-ion half-cell depicting the layers depicted in FIG. 15 above, interspersed between a Li metal electrode atop a combination of a separator and a liquid electrolyte.

FIG. 17 is a cross sectional view of the anode structure depicted in FIG. 15 wherein the single crystal p or n-doped particles has been lithiated.

### THE PREFERRED EMBODIMENTS

It is to be understood that embodiments of the present invention are not limited to the illustrative methods, apparatus, structures, systems and devices disclosed herein but instead are more broadly applicable to other alternative and broader methods, apparatus, structures, systems and devices that become evident to those skilled in the art given this disclosure.

In addition, it is to be understood that the various layers, structures, and/or regions shown in the accompanying drawings are not drawn to scale, and that one or more layers, structures, and/or regions of a type commonly used may not be explicitly shown in a given drawing.

This does not imply that the layers, structures, and/or regions not explicitly shown are omitted from the actual devices.

In addition, certain elements may be left out of a view for the sake of clarity and/or simplicity when explanations are not necessarily focused on such omitted elements.

Moreover, the same or similar reference numbers used throughout the drawings are used to denote the same or similar features, elements, or structures, and thus, a detailed explanation of the same or similar features, elements, or structures will not be repeated for each of the drawings.

The devices, structures, and methods disclosed in accordance with embodiments of the present invention can be employed in applications in the semiconductor and electronics applications like hardware and/or electronic systems including but are not limited to, personal computers, communication networks, electronic commerce systems, portable communications devices, (e.g., cell and smart phones), internet-of-things (IoT), solid-state media storage devices, expert and artificial intelligence systems, functional circuitry, neural networks, etc.

However, uses are also found in other high energy density larger energy storage systems including battery powered vehicles (e.g., cars, trucks, boats, trains, etc.); energy storage for housing, office buildings, and other structures; and industrial power storage including storage of intermittent power generation (e.g., wind and solar power generation); etc.

As used herein, “height” refers to a vertical size of an element (e.g., a layer, trench, hole, opening, etc.) in the cross-sectional or elevation views measured from a bottom surface to a top surface of the element, and/or measured with respect to a surface on which the element is located.

Conversely, a “depth” refers to a vertical size of an element (e.g., a layer, trench, hole, opening, etc.) in the cross-sectional or elevation views measured from a top surface to a surface of the element. Terms such as “thick”, “thickness”, “thin” or derivatives thereof may be used in place of “height” where indicated.

As used herein, “lateral,” “lateral side,” “side,” and “lateral surface” refer to a side surface of an element (e.g., a layer, opening, etc.), such as a left or right-side surface in the drawings.

As used herein, “width” or “length” refers to a size of an element (e.g., a layer, trench, hole, opening, etc.) in the drawings measured from a side surface to an opposite surface of the element. Terms such as “thick”, “thickness”, “thin” or derivatives thereof may be used in place of “width” or “length” where indicated.

As used herein, terms such as “upper”, “lower”, “right”, “left”, “vertical”, “horizontal”, “top”, “bottom”, and derivatives thereof shall relate to the disclosed structures and methods, as oriented in the drawing figures. For example, as used herein, “vertical” refers to a direction perpendicular to the top surface of the substrate in the elevation views, and “horizontal” refers to a direction parallel to the top surface of the substrate in the elevation views.

As used herein, unless otherwise specified, terms such as “on”, “overlying”, “atop”, “on top”, “disposed on”, “positioned on” or “positioned atop” mean that a first element is present on a second element, wherein intervening elements may be present between the first element and the second element.

As used herein, unless otherwise specified, the term “directly” used in connection with the terms “on”, “overlying”, “atop”, “on top”, “positioned on” or “positioned atop,” “disposed on,” or the terms “in contact” or “direct contact” means that a first element and a second element are connected without any intervening elements, such as, for example, intermediary conducting, insulating or semiconductor layers or formed electrochemical layers, present between the first element and the second element. It is understood that these terms might be affected by the orientation of the device described. For example, while the meaning of these descriptions might change if the device was rotated upside down, the descriptions remain valid because they describe relative relationships between features of the invention.

Embodiments of this invention include various cathode materials and structures in various lithium battery embodiments also having various anode structures with or without a surface oxide as well as those with no porosity or different porosities.

Embodiments enable plating and stripping of a lithium metal layer on an anode surface, e.g., a smooth anode surface with or without a nucleation layer. The nucleation can be achieved on a thin semiconductor surface or on an oxide surface. Examples of surfaces include but not limited to virgin single crystal silicon surface, with or without a native oxide, deposited oxide, chemical oxide or thermally grown SiO₂, or porous Si surface, disposed on a conductive current collector.

The surface layers described above enable a lithium metal layer to form above it and easily vary (grow and shrink) in thickness during battery charge and discharge cycles with no or a minimum of lithium intercalation/deintercalation.

In some embodiments, the smoothness of the above-described Si surfaces inhibit or prevent dendrite growth on/in the anode and therefore prevent battery deterioration and/or the electrical shorting of internal battery components, e.g., shorting to the cathode and electrolyte.

As used herein, “plating” means deposition of lithium metal and/or lithium atoms/ions to form a lithium metal layer of variable thickness upon a surface. “Stripping” means the removal of lithium atoms/ions and electrons from the lithium metal layer causing the lithium metal layer to shrink. Plating causes the lithium metal layer to grow (become thicker), for example, during charging or during the Li electroplating process. Stripping decreases the thickness of the lithium metal layer as lithium atoms (lithium ions and associated electron) leave the lithium metal layer, e.g., during discharging.

This disclosure describes various embodiments that provide anode surfaces and thicknesses that repeatedly permit lithium metal layers to form (grow during charging and shrink during discharging cycles) with minimal or no mechanical failure effects on battery components or significant dendrite growth.

“Uniform” plating means that a lithium metal layer plated on a surface is a predominantly continuous lithium layer across the entire area of a surface. This lithium layer can be wavy and non-uniform in thickness or the thickness can be constant over the entire surface.

It is thought that this uniform plating of the lithium metal layer, e.g., on the smooth virgin or oxidized or porous-Si surface, prevents or largely inhibits dendrite formation, particularly when the surface of the lithium metal layer is smooth.

In some embodiments of the present invention, an anode is made by disposing a thin, n or p-type doped single crystal semiconductive layer on a conductive current collector layer.

The semiconductive layer has a native, chemical, electrochemical or thermal oxide or a porous surface layer on which lithium nucleates, e.g., the lithium intercalates/reacts with the semiconductor to form a lithium seed layer on/in the semiconductor surface. The lithium metal layer will grow and shrink during the charge and discharge cycling of the battery.

In some embodiments, the semiconductor layer is made from single crystal silicon.

Accordingly, the semiconductor layer used as a nucleation layer will be referred to as a nucleation layer, silicon layer, crystal silicon layer, or single crystal silicon layer, etc. without loss of generality, even though other semiconductor materials and structures are envisioned for making the semi-conductor layer.

In addition, because of the smoothness of the silicon layer, the plated lithium metal layer will be uniformly/continuously spread over the semiconductor surface. As a result, dendrite formation will be greatly reduced or eliminated.

In some embodiments, the semiconductor nucleation layer is either n or p-doped single crystal Si with or without a surface SiO₂ or porous-Si with pores of such a size to enable a lithium seed layer formation that helps the more efficient formation of the lithium metal layer.

Larger, e.g., thicker, cathodes with higher loading, e.g., >20 mg/cm² can provide more lithium for the higher current densities enabled in these anodes with greater energy densities. However, high-loaded cathodes, while providing more lithium, can decrease the charging and discharging rates of the battery because of the increased time the lithium takes to migrate through the thicker cathode during charge/discharge cycles.

The resistivity of the anode in conjunction with its lithiation are the two most important characteristics in the present invention. Additionally, an ohmic contact of the current collector to the seed layer on the anode is a pre-requisite to obtain best performance from the battery.

Battery resistance includes both the ionic resistance and electronic resistance. Ionic resistance refers to the resistance of Li-ions in the electrolyte, the resistance of lithium ions through the SEI film, and the charge transfer resistance of lithium-ions and electrons at the active material/SEI film interface, and the solid phase diffusion resistance of lithium ions inside the active material.

Electronic resistance refers mainly to the resistance of positive and negative active materials, current collector resistance, contact resistance between active materials, contact resistance between active materials and current collector.

The separators used in the present invention must be chemically and electrochemically stable to the electrolyte and electrode materials in Li-ion batteries since the separator itself does not participate in any cell reactions. Separators for conventional, planar Li-ion batteries are typically solid micro-porous polyolefin films.

As a critical component inside Li-ion batteries under strongly oxidizing and reducing conditions when the battery is fully discharged and charged, separators should also be mechanically strong to withstand the high tension during the battery assembly operation.

Typically, separators in commercial lithium-ion batteries have found to be formed from polyethylene and polypropylene.

The current collector works as electrical conductor between the electrode and external circuits as well as a support for the coating of the electrode materials.

### DETAILED DESCRIPTION OF THE PREFERRED EMBODIMENTS

While use of a lithiated porous-Si layer in a p-type Si only has been found to be effective for use in a Li-ion battery in the prior art, the present invention comprising the electrochemical lithiation of chemically oxidized virgin single crystal Si of both n and p-type provides the same high performance. Two key parameters enabling this similar result are: the low resistivity of the Si and its electrochemical lithiation. By use of the present invention, one can affect roll-to-roll implementation of the Si anode by using single crystal p or n-doped particles, spraying them over a calendared conducting carbon slurry or other conductive mediums with a strong adhesive and standard organic solvents, such as N-methyl-2-pyrrolidone, (NMP), polyvinylidene fluoride) (PVD) etc., and subsequently lithiating them.

The present invention has three embodiments.

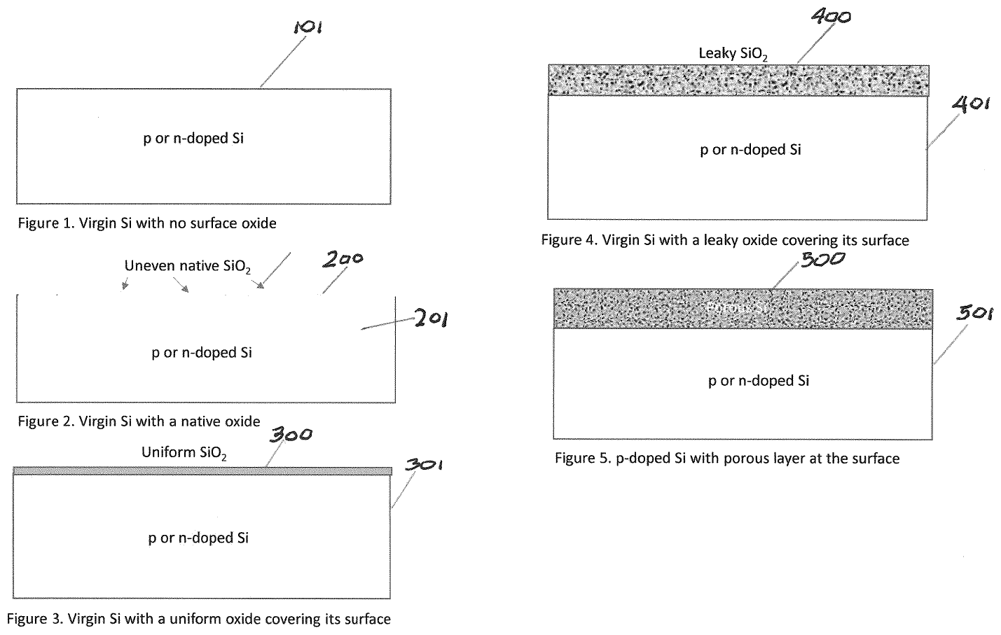

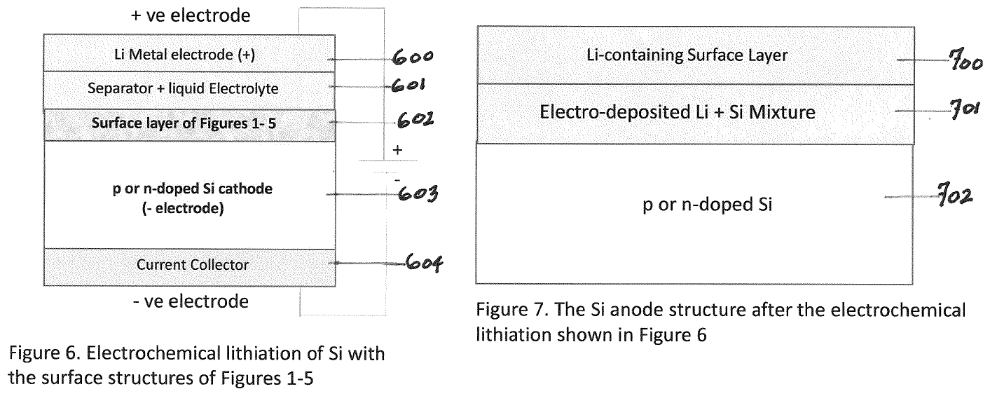

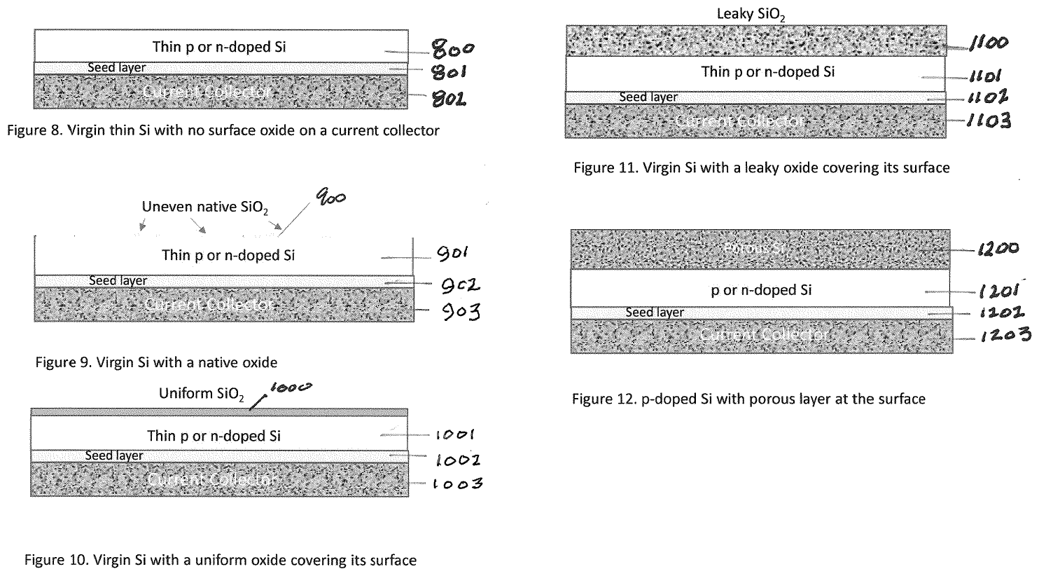

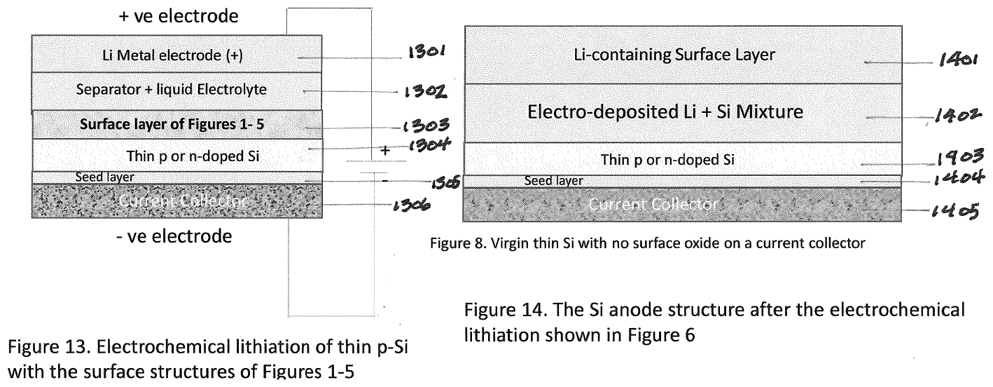

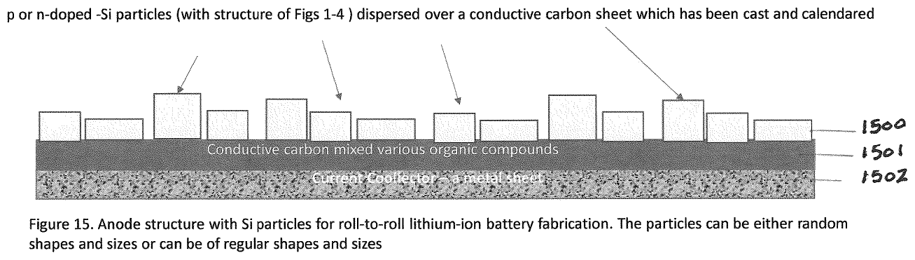

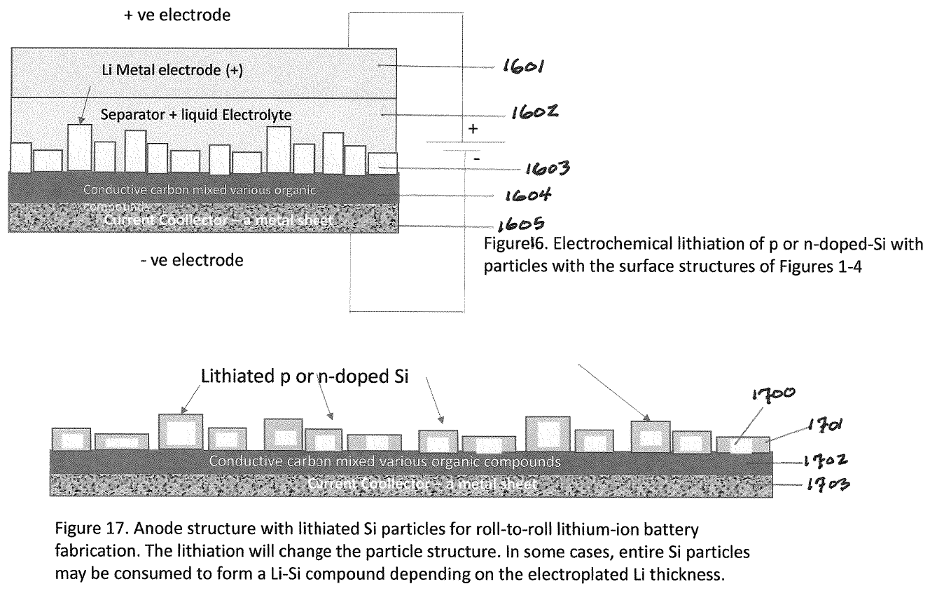

As a first embodiment, FIG. 1 depicts an element to be used as an anode in a Li-ion battery comprising a thick p or n-doped virgin single crystal Si without an oxide layer on its upper surface. The virgin single crystal Silicon consist of commercially available Si wafers that are either polished on one side or both sides. While the description of the Si is expressed herein as “virgin Silicon,” other forms of Si can be successfully used. The “single crystal porous —Si/p-Si” described herein is formed starting with a single crystal p-Si substrate and during an anodic etching, the surface region of same converts into a porous Si region.

FIG. 1 shows a schematic of a single crystal p or n-Si element 101 that is doped with either Boron (B) for p-type Si, and Phosphorous (P) or Arsenic (As) doped for n-type Si at concentrations of >10¹⁸ cm⁻³, and typically has resistivity of <0.01 Ohm cm. The preferred resistivity range is 0.01-0.002-ohm cm.

FIG. 2 depicts the single crystal p or n-doped element 201 having the properties depicted in FIG. 1, wherein the upper surface of the single crystal p or n-doped element contains an uneven layer of native SiO₂ (200).

Native oxide is a very thin layer of SiO₂ of approximately 1.5 nm or less that forms on the surface of a silicon wafer whenever the wafer is exposed to air under ambient conditions. The average thickness of the uneven layer is between about 1.0 and 1.5 nm.

FIG. 3 depicts the single crystal p or n-doped element 301 having the properties described above relating to FIG. 1, wherein the upper surface of the single crystal p or n-doped element is covered with a uniform layer of SiO₂ (300). The thickness of the uniform layer is between about 1 nm and 3 nm.

FIG. 4 depicts the single crystal p or n-doped element having the properties described above relating to FIG. 1, wherein the upper surface of the single crystal p or n-doped element 401 is covered with a “leaky” layer of native SiO₂ (400). The leaky layer is defined as which can pass a current of >100 μA/cm² at 1 volt and has a thickness of between about 10 nm and 100 nm.

FIG. 5 depicts the p-doped Si element 501, wherein its upper surface is porous (500) and has a porosity of between about 30% and 75%. The thickness of porous layer 500 is between about 1 μm and 100 μm.

FIG. 6 depicts elements present in the electrochemical lithiation of any of the structures in FIGS. 1-5. The Li-ion half-cell product depicted in FIG. 6 comprises a Li metal positive electrode layer 600 having a thickness of between about 50 and 200 μm positioned intermediately above a liquid electrolyte-soaked separator layer 601, jointly having a thickness of between about 5 μm and 20 μm under pressed condition inside a battery cell, which, in turn, is atop any of the structures described with respect to, and depicted in FIGS. 1-5 602, which are positioned atop a single crystal p or n-doped cathode 603 serving as a negative electrode having a thickness of <500 μm atop a current connector 604 having a thickness of between about 5 and 25 μm.

Various types of electrolyte/separators are envisioned. The electrolyte can be in a liquid or solid-state form. Non-limiting examples of solid-state electrolyte materials include, polymer electrolytes, sulfide solid electrolytes (SSEs), argyrodite electrolytes, sulfur containing electrolytes like Li₆PS₅Cl, and lithium phosphorous oxynitride (UPON) ceramic type electrolytes.

The Li metal electrode 600 is disposed on the electrolyte/separator 601. The Li metal electrode 600 is made of either pure Li metal or lithium containing compounds that has thickness of between about 50 and 200 μm. Any known Li metal electrode material that is a source for lithium is envisioned.

Non-limiting examples of the Li metal containing cathode material include lithium salts, such as lithium cobalt oxide (LCO), nickel manganese cobalt oxide (NMC), lithium iron phosphate (LFP), and compounds generally designated as NCA, which are composed of the chemical elements: lithium, nickel, cobalt and aluminum.

Other representative cathodes have Li [symbol] halides, such as LiI (lithium iodide), etc.

Generally, the thicker the Li metal containing cathode material, the more is the cathode loading and larger amount of lithium is available in the battery. Typically, a cathode loading of <20 mg/cm² is used to avoid the formation Li dendrites during the battery charge-discharge cycling.

The current collector for the anode can be nickel or copper.

The electrochemical lithiation process of FIG. 6, comprises the following steps:
1. A single crystal p or n-Si substrate (having a doping of ˜10¹⁹ cm⁻³, and resistivity ˜0.005-ohm cm) is cleaned in well-known inorganic and organic solvents such as hot acetone, dimethylformamide etc, or other suitable chemical cleaning that is typically used in the Si IC industry;
2. For the porous-Si anode, a single crystal p-Si substrate is used and it is electrochemically etched (anodic etching) in a 40-50% concentrated HF with or without a surfactant such as ethanol, acetic acid, dimethylformamide etc., to form a porous-Si region at the surface;
3. A half-cell with a Li-metal anode and said p or n-Si as a cathode (or p-Si only for a porous-Si cathode) is formed with a typical liquid electrolyte and a separator to facilitate Li deposition on said Si;
4. A lithiation process is performed on the Si cathode via a constant current (range 1-10 mA/cm²) to obtain >5 μm Li deposition on the Si surface;
5. The lithiated Si after step 4 is subsequently used as an anode in a lithium-ion battery.

FIG. 7 depicts a formed anode structure resulting from the electrochemical lithiation process cited above with respect to the FIG. 6 structure, comprising a Li-containing surface layer 700, having a thickness of between about 20 nm and 50 μm atop layer 701 comprising an electrodeposited Li plus reacted Li—Si mixture, having a thickness of between about 10-50 μm, atop a single crystal p or n-doped layer 702 having a thickness of between about 50 μm and 1000 μm. The resultant anode structure of FIG. 7 is compatible with a high cathode loading of greater than 20 mg/cm² and a low-capacity fade of less than 0.05% per cycle at a C/10 or lower rate during first 100 cycles in a lithium-ion battery. These properties are important for a long battery life.

As a second embodiment, FIG. 8 depicts a virgin thin layer of a single crystal p or n-doped Si 800, having a thickness of between about 5 μm and 100 μm atop a seed layer 801 having a thickness of between about 10 nm and 1000 nm atop a current collector 802 having a thickness of between about 5 μm and −50 μm. The seed layer 801 is deposited on virgin thin single crystal p or n-doped Si 800 and the current collector 802 is bonded to the seed layer 801. The structure of FIG. 8 does not possess an oxide layer on its upper surface. The composition of the single crystal p or n-doped and the current collector is as defined in in the description relating to FIG. 1 above. The seed layer comprises a bilayer of Ti and Cu or Cr and Cu, or Ti and Ni to improve both the adhesion and ohmic contact to the current collector, conveniently formed from electroplated Cu or Ni.

FIG. 8 depicts the single crystal p or n-doped element 800 having the properties described above relating to FIG. 1, wherein the upper surface of the single crystal p or n-doped element 800 has no oxide thereon.

FIG. 9 depicts the single crystal p or n-doped element 901 having the properties described above relating to FIGS. 1 and 8, wherein the upper surface of the single crystal p or n-doped element contains an uneven layer of native SiO₂ 900. Native oxide, i.e., SiO₂ layer 900 has a thickness of approximately 1.5 nm.

The average thickness of the uneven layer is between about 1 nm and 1.5 nm. Layers 900 and 901 respectively are atop a seed layer 902 atop a current collector 903. Seed layer 902 is a bilayer of Ti and Cu or Cr and Cu or Ti and Ni to improve the adhesion of the Cu or Ni current collector deposited on the seed layer by electroplating. Other deposition methods including but not limited to sputtering, and electroless plating of Cu or Ni are also considered.

FIG. 10 depicts a single crystal p or n-doped element 1001 having the properties described above relating to FIGS. 1 and 8, wherein the upper surface of the single crystal p or n-doped element is covered with a uniform layer of SiO₂ 1000. The thickness of the uniform layer is between about 1 nm and 3 nm. Thicker than 3 nm oxide will adversely impact the lithiation process due to the high electrical resistance of the oxide. Layers 1000 and 1001 respectively are atop a seed layer 1002 atop a current collector 1003. Seed layer 1002 is a bilayer of Ti and Cu or Ni or Cr and Cu to improve both the adhesion and ohmic contact to the Cu or Ni current collector deposited on the seed layer by electroplating. Other deposition methods including but not limited to sputtering, and electroless plating of Cu or Ni are also considered.

FIG. 11 depicts the single crystal p or n-doped element 1101 having the properties described above relating to FIGS. 1 and 8, wherein the upper surface of the single crystal p or n-doped element 1101 is covered with a “leaky” layer of SiO₂ 1100. Leaky layer 1100 is defined as the one that allows >100 μA/cm² at 1 Volt and has a thickness of between about 5 nm and 1000 nm. Layers 1100 and 1101 respectively are atop a seed layer 1102 atop a current collector 1103. Seed layer 1102 is a bilayer of Ti and Cu or Cr and Cu, or Ti and Ni to improve both the adhesion and ohmic contact to the Cu or Ni current collector deposited on the seed layer by electroplating. Other deposition methods including but not limited to sputtering, and electroless plating of Cu or Ni are also considered.

FIG. 12 depicts the single crystal p or n-doped element 1201 having the properties described above relating to FIGS. 1 and 8, wherein the upper surface of the single crystal p or n-doped element 1201 is covered with a layer of SiO₂ 1200 having a porosity of between about 30% and 75%.

The thickness of the porous layer is between about 1 μm and 100 μm. Layers 1200 and 1201 respectively are atop a seed layer 1202 atop a current collector 1203. Seed layer 1202 is a bilayer of Ti and Cu, Ti and Ni or Cr and Cu to improve both the adhesion and ohmic contact to current collector 1203, which is formed from electroplated Ni or Cu.

FIG. 13 depicts a Li-ion half-cell structure suitable for electrochemical lithiation comprising a Li electrode layer 1301 having a thickness between about 50 μm and 200 μm atop a separator soaked with a liquid electrolyte layer 1302, jointly having a thickness of between about 5 μm and 25 μm under pressed condition inside a battery cell, which is atop a surface layer 1303 comprising any of the structures shown in FIGS. 1-5 and 8-12. Surface layer 1303 is positioned atop a layer of thin single crystal p or n-doped 1304, atop a seed layer 1305 atop a current collector 1306. The composition of the seed layer 1305 and current collector 1306 is as stated above with respect to FIGS. 8-12.

An example method of forming the structure is as follows:
1. Obtain virgin single crystal n or p-Si of thickness 380-750 μm.
2. Deposit a Ti or Cr seed layer of 10-30 nm followed by Cu deposition of 200-500 nm on the back of the thinned Si using a standard sputtering method in an Ar plasma as known in the prior art
3. Perform electroplating of Cu to a thickness of >10 μm
4. Chemically thin the structure after step 3 by using a mixture of HNO₃+HF+CH₃COOH (10:2:5 vol.) to 25-100 μm while keeping the back surface with electroplated Cu protected from the mixture of HNO₃+HF+CH₃COOH
5. Perform oxidation of the thinned Si in H₂O₂ at 65° C. for 10 minutes.

Many other chemical and electrochemical methods of thinning Si and its oxidation are considered.

FIG. 14 depicts a formed anode structure resulting from the electrochemical lithiation process cited above with respect to the FIG. 13 structure, comprising a Li-containing surface layer 1401, having a thickness of between about 20 nm and 50 μm atop a layer comprising an electrodeposited Li plus Li reacted Si mixture 1402, having a thickness of between about 10 and 50 μm atop a single crystal p or n-doped layer 1403 having a thickness of between about 50 μm and 1000 μm.

Surface layer 1401 positioned atop, electrodeposited Li plus Li reacted Si mixture 1402 atop single crystal p or n-doped layer 1403 are respectively positioned atop a seed layer 1404 atop a current collector 1405.

The composition of the seed layer 1305 and current collector layer 1306 is as stated with respect to FIGS. 8-12. The composition of the seed layer 1305 and current collector lar 1306 is as stated with respect to FIGS. 8-12.

The resultant anode structure of FIG. 14 is compatible with a high cathode loading of greater than 20 mg/cm² and a low-capacity fade of less than 0.05% per cycle during first 100 cycles at a charge/discharge rate of C/10 or lower. These properties are important for a long life of a high-capacity battery.

As a third embodiment, FIG. 15 depicts a structure suitable for use in an anode in a Li-ion battery having a plurality of single crystalline p or n-doped particles 1500 having the structures defined in FIGS. 1-4 dispersed over a strong electrical conductive adhesive mixed with non-Li reactive organic compounds 1501, positioned atop a current collector 1502. The structure as depicted either has been cast and calendared or the Si particles have been sprayed over a strong electrically conductive adhesive mixed with non-Li reactive organic compounds.

The p or n-doped particles 1500 in the FIG. 15 structure are single crystalline with either random shapes or sizes or can be of regular shapes and sizes. The structure is especially suitable for roll-to-roll Li-ion fabrication.

Each of the single crystal p or n-doped particle 1500 of this embodiment whether of irregular or regular shape, have dimensions relating to volume or thickness of between about 10 μm and 100 μm, and possess the following other properties: an n or p-doping levels greater than 10¹⁸ cm⁻³ and resistivities of <0.01-ohm cm. The thickness of the strong electrically conductive adhesive mixed with non-Li reactive organic compounds is <20 μm, positioned atop a current collector 1502. The combined structure depicted in FIG. 15 is a precursor to the structure depicted in FIG. 17 after a lithiation treatment.

FIG. 16 depicts a Li-ion half-cell structure suitable for electrochemical lithiation comprising a Li metal electrode layer 1601, having a thickness of between about 20 nm and 50 μm atop a layer comprising a separator soaked with a liquid electrolyte 1602, having a thickness of between about 10 and 50 μm which together are in contact with and atop a single crystal p or n-doped layer 1603 consisting of particles of random shapes and dimensions having thicknesses of between about 10 μm and 200 μm atop a layer of a strong electrical conductive adhesive mixed with non-Li reactive organic compounds positioned atop a current collector 1605. The resultant anode structure of each particle after the lithiation should resemble to those of FIG. 7 and FIG. 14.

FIG. 17 depicts an anode structure wherein the single crystal p or n-doped particles as described above relating to the FIGS. 15 and 16 are lithiated. The anode structure of FIG. 17 with its lithiated Si particles am especially suitable for roll-to roll Li-ion fabrication. Lithiation changes the particle structure. In some instances, entire Si particles may be consumed to form a Li—Si compound depending on the electroplated thickness of Li.

The anode structure of FIG. 17 comprises silicon particles 1700 that have been lithiated to possess a lithium coating 1701, atop a layer 1702 comprising a strong conductive adhesive mixed with non-Li reactive organic compounds positioned atop a current collector 1703.

The thickness of the layer of lithiated single crystal p or n-doped particles is between about 10 μm and 100 μm and these are attached to a strong electrically conductive adhesive mixed with non-Li reactive organic compounds positioned atop a current collector. The thickness of the electrically conductive adhesive layer atop the Ni/Cu current collector is as stated in the description relating to FIG. 15.

The resultant anode structure of FIG. 17 is compatible with a high cathode loading of greater than 20 mg/cm² and a low-capacity fade of less than 0.05% per cycle first 100 cycles at a charge/discharge rate of C/10 or lower. The importance of these properties is stated above.

Other methods of Li deposition but not limited to vacuum evaporation and sputtering are also envisioned. The thickness range of Li deposition is the same as already described above for the electrochemical lithiation. Both vacuum and sputtering depositions will require appropriate safety protocols so that the Li is never exposed to an air or any oxidizing environment during the entire deposition process and subsequent formation of lithium-ion batteries.

### Summary of the Instant Disclosure

As disclosed hereinabove, in accordance with the present invention a high-performance lithium-ion battery is obtained via the electrochemical lithiation of virgin single crystal p-doped Si with a chemical oxide. The lithiation process described provides the same high performance as that achieved using a lithiated porous-Si layer. The key parameters enabling this remarkable behavior are—low resistivity of the Si and its electrochemical lithiation. The present invention enables roll-to-roll implementation of the Si anode by using p- or n-doped Si particles, spraying them over a calendared conducting carbon slurry with standard organic solvents, such as NMP, PVDF etc., and subsequently lithiating them. There are three embodiments disclosed in this invention.

### Embodiment 1

Thick p- or n-doped Si with and without various types of oxide (FIGS. 1-4).

Thick p- or n-doped Si with a porous layer of 30-75% porosity (FIG. 5).

Electrochemical lithiation of all the structures in FIGS. 1-5 (FIG. 6).

Formation of the anode structure with Li-containing surface and Li—Si mixture (FIG. 7).

High cathode loading (>20 mg/cm2).

Low-capacity fade (<0.05% per cycle first 100 cycles) at a C/10 or lower rate.

### Embodiment 2

Thin p- or n-doped Si on a current collector (either deposited or bonded to thin Si) with and without various types of oxide (FIGS. 8-11).

Thin p- or n-doped Si with a porous layer of 30-75% porosity (FIG. 12).

Electrochemical lithiation of all the structures in FIG. 13.

Formation of the anode structure with Li-containing surface and Li—Si mixture (FIG. 14).

High cathode loading (>20 mg/cm2).

Low-capacity fade (<0.05% per cycle first 100 cycles) a C/10 or lower rate

### Embodiment 3

p- or n-doped Si particles of regular and irregular shapes, dimensions, and thicknesses, and having the structure shown in FIGS. 1-4 dispensed over a conductive carbon slurry calendared on a current collector (FIG. 15).

Electrochemical lithiation of all the structures in FIG. 15 and FIG. 16.

Formation of the anode structure on the Si particles with Li-containing surface and Li—Si mixture (FIG. 17).

High cathode loading (>20 mg/cm2).

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

Devices, components, elements, features, apparatus, systems, structures, techniques, and methods described with different terminology that perform substantially the same function, work in the substantial the same way, have substantially the same use, and/or perform the similar steps are contemplated as embodiments of this invention.

What we claim and desire to protect by Letters Patent is:

1. An element to be used as an anode suitable for use in a Li-ion battery comprising an electrochemically lithiated p or n-doped virgin single crystal Si having a layer with an upper surface devoid of an oxide;
said p or n-Si being doped with either B for p-type Si, and P or As for n-type Si at concentrations of >2×10¹⁸ cm⁻³, and having a resistivity of <0.01 Ohm cm.

2. The element defined in claim 1 wherein said resistivity range is between about 0.01 and 0.001 ohm·cm.

3. The element defined in claim 1 wherein said upper surface of said layer comprises an uneven coating thereon of SiO₂, said uneven coating on said layer having a SiO₂ average thickness of between about 1.0 and 1.5 nm, upon exposure to air under ambient conditions.

4. The element defined in claim 1 wherein said upper surface of said layer comprises a uniform even coating thereon of SiO₂, the thickness of said uniform layer being between about 1 nm and 3 nm.

5. The element defined in claim 1 wherein said upper surface of said layer comprises a leaky coating thereon of SiO₂ said leaky SiO₂ layer having a thickness of between about 10 nm and 100 nm and is adapted to pass a current of >100 μA/cm² at 1 volt.

6. The element defined in claim 1 wherein said upper surface of said layer comprises a porous silicon, said porous silicon layer having a porosity of between about 30% and 75% and a thickness between about 1 μm and 100 μm.

7. A structure adapted to form an anode suitable for use in a Li-ion battery after an electrochemical lithiation of said element defined in claim 1, the structure for electrochemical lithiation comprises: a Li metal positive electrode layer having a thickness of between about 50 and 200 μm positioned intermediately above a separator soaked with a liquid electrolyte layer, said separator-electrolyte layer jointly having a thickness of between about 5 μm and 25 μm under pressed condition inside a battery cell, which in turn is atop said p or n-doped single crystal Si cathode with an upper surface devoid of or
optionally containing SiO₂ serving as a negative electrode having a thickness of <1000 μm atop a current connector having a thickness of between about 5 and 25 μm.

8. The structure to be used as an anode suitable for use in a Li-ion battery defined in claim 7 wherein said electrochemically lithiated p or n-doped virgin Si has a thickness <200 μm having a layer wherein an upper surface of said electrochemically lithiated p or n-doped virgin Si is devoid of an oxide and is positioned atop a Ti/Cu or Ti/Cr seed layer having a combined thickness of between about 20 nm and 500 nm, which is positioned atop a current collector having a thickness of between about 5 μm and 100 μm.

9. The structure to be used as an anode suitable for use in a Li-ion battery defined in claim 7 wherein said electrochemically lithiated p or n-doped virgin Si has a thickness <200 μm having a layer wherein an upper surface of said electrochemically lithiated p or n-doped virgin single crystal Si is an Si oxide selected from uneven native SiO₂, uniform even SiO₂, leaky SiO₂ and porous SiO₂ and is positioned atop a Ti/Cu or Ti/Cr seed layer having a combined thickness of between about 20 nm and 500 nm, which is positioned atop a current collector having a thickness of between about 5 μm and 100 μm.

10. The structure defined in claim 7 wherein said uneven layer of native SiO₂ has a thickness of 1.5 nm or less when said single crystal p or n-doped structure is exposed to air under ambient conditions; or
wherein said upper surface of said single crystal p or n-doped element is covered with a uniform layer of SiO₂ which uniform layer has a thickness of between about 1 nm and 3 nm; or
wherein said upper surface of the single crystal p or n-doped element is covered with a “leaky” layer of SiO₂, said leaky layer capable of passing a current of >100 μA/cm² at 1 volt and has a thickness of between about 10 nm and 100 nm; or
wherein said upper surface of the single crystal p doped element is covered with a porous silicon layer and has a porosity of between about 30% and 75% with a thickness of said porous layer between about 1 μm and 100 μm.

11. A formed anode structure that results from the electrochemical lithiation process applied to the structure defined in claim 7, comprising a Li-containing surface layer, having a thickness of between about 10 nm and 50 μm atop a layer comprising an electrodeposited Li plus reacted Li—Si mixture, having a thickness of between about 10-50 μm, atop a single crystal p or n-doped layer having a thickness of between about 50 μm and 1000 μm.

12. The single crystal p or n-doped Si defined in claim 11 has a resistivity range between about 0.01 and 0.001 ohm cm.

13. The structure defined in claim 10 wherein said electrochemically lithiated p or n-doped virgin single crystal Si of thickness <200 μM has an uneven surface SiO₂ of an average thickness of between about 1.0 and 1.5 nm, upon exposure to air under ambient conditions, is positioned atop a Ti/Cu or Ti/Cr seed layer having a combined thickness of between about 20 nm and 500 nm, which is positioned atop a current collector having a thickness of between about 5 μm and 100 μm.

14. The structure defined in claim 10 wherein said electrochemically lithiated p or n-doped virgin single crystal Si of thickness <200 μm has an even surface SiO₂ of an average thickness of between about 1.0 and 3.0 nm, upon exposure to air under ambient conditions, is positioned atop a Ti/Cu, Ti/Ni or Ti/Cr seed layer having a combined thickness of between about 20 nm and 500 nm, which is positioned atop a current collector having a thickness of between about 5 μm and 100 μm.

15. The structure defined in claim 10 wherein said electrochemically lithiated p or n-doped virgin single crystal Si comprises a layer with an upper surface, wherein said upper surface of said layer comprises a leaky coating thereon of SiO₂, said leaky SiO₂ layer having a thickness of between about 10 nm and 100 nm and passing a current of >100 μA/cm² at 1 volt, and is positioned atop a Ti/Cu, Ti/Ni or Cr/Cu seed layer having a combined thickness of between about 20 nm and 500 nm, which is positioned atop a current collector having a thickness of between about 5 μm and 100 μm.

16. The structure defined in claim 10 wherein said electrochemically lithiated p-doped virgin single crystal Si has a thickness <1000 μm with an upper porous-Si surface, wherein said upper surface is a chemically oxidized porous silicon layer having a porosity of between about 30% and 75% and a thickness between about 1 μm and 100 μm.

17. The structure adapted to form an anode that results from the electrochemical lithiation process defined in claim 7 as applied to said structure, comprising a Li-containing surface layer, having a thickness of between about 20 nm and 50 μm atop a layer comprising an electrodeposited Li plus reacted Li—Si mixture, having a thickness of between about 10-150 μm, atop a single crystal p or n-doped layer having a thickness of between about 50 μm and 1000 μm, atop a Ti/Cu, Ti/Ni or Cr/Cu seed layer having a combined thickness of about 20 nm and 500 nm atop a current collector selected from Ni or Cu, having a thickness between about 5 μm and 50 μm, wherein a resultant battery structure with the said lithiated anode structure has a low-capacity fade of less than 0.05% per charge/discharge cycle during the first 100 cycles at a C/10 or lower charge rate.

18. A structure suitable for use as an anode in a Li-ion battery comprising an electrochemically lithiated p or n-doped virgin single crystal Si having a layer with an upper surface devoid of an oxide;
said p or n-Si being doped with either Boron for p-type Si, and Phosphorus or Arsenic for n-type Si at concentrations of >2×10¹⁸ cm⁻³ and having a resistivity of <0.01 Ohm/cm, atop a seed layer selected from Ti/Cu, Ti/Ni or Cr/Cu seed layer having a combined thickness of between about 20 nm and 500 nm, atop a current collector selected from Ni or Cu and having a thickness of between about 5 μm and 100 μm.

19. The virgin single crystal Si defined in claim 1 wherein said resistivity range is between about 0.01 and 0.001 ohm·cm.

20. The element defined in claim 19 wherein said electrochemically lithiated p or n-doped virgin single crystal Si has an upper surface containing an uneven coating thereon of SiO₂, said uneven coating on said layer having a SiO₂ average thickness of between about 1.0 and 1.5 nm, upon exposure to air under ambient conditions, atop a seed layer selected from Ti/Cu, Ti/Ni or Cr/Cu having a combined thickness of between about 20 nm and 500 nm, atop a current collector selected from Ni or Cu and having a thickness of between about 5 μm and 100 μm.

21. The element defined in claim 19 wherein said electrochemically lithiated p or n-doped virgin single crystal Si has an upper surface containing a uniform even coating thereon of SiO₂, said even coating on said layer having a SiO₂ average thickness of between about 1.0 and 1.3 nm, atop a seed layer selected from Ti/Cu, Ti/Ni or Cr/Cu having a combined thickness of between about 20 nm and 500 nm, atop a current collector selected from Ni or Cu and having a thickness of between about 5 μm and 100 μm.

22. The element defined in claim 19 wherein said electrochemically lithiated p or n-doped virgin single crystal Si has an upper surface containing a leaky coating thereon of SiO₂ said leaky SiO₂ layer having a thickness of between about 10 nm and 100 nm and passing a current of >100 μA/cm² at 1 volt, atop a seed layer selected from Ti/Cu, Ti/Ni or Cr/Cu having a combined thickness of between about 20 nm and 500 nm, atop a current collector selected from Ni or Cu and having a thickness of between about 5 μm and 100 μm.

23. The element defined in claim 19 wherein said electrochemically lithiated p or n-doped virgin single crystal Si has a upper surface containing a porous silicon coating layer thereon, said porous silicon coating layer having a porosity of between about 30% and 75% and a thickness between about 1 μm and 100 μm, atop a seed layer selected from Ti/Cu, Ti/Ni or Cr/Cu seed layer having a combined thickness of between about 20 nm and 500 nm, atop a current collector selected from Ni or Cu and having a thickness of between about 5 μm and 100 μm.

24. A Si anode structure suitable for lithiation to form a Li-ion battery comprising: a lithium metal electrode atop a liquid electrolyte soaked separator atop a surface layer comprising a single crystal p or n-doped structure having a layer with an upper surface devoid of or optionally containing SiO₂ which is positioned atop a thin single crystal p or n-doped cathode serving as a negative electrode having a thickness of <1000 μm atop a seed layer selected from Ti/Cu, Ti/Ni or Cr/Cu seed layer having a combined thickness of between about 20 nm and 500 nm, atop a current collector selected from Ni or Cu and having a thickness of between about 5 μm and 100 μm.

25. The Si anode structure defined in claim 24 wherein said single crystal p or n-doped structure has an upper surface that is devoid of SiO₂.

26. The Si anode structure defined in claim 24 element wherein said electrochemically lithiated p or n-doped virgin single crystal Si has an upper surface containing an uneven coating thereon of SiO₂, said uneven coating on said layer having a SiO₂ average thickness of between about 1.0 and 1.5 nm, upon exposure to air under ambient conditions.

27. The Si anode structure defined in claim 24 wherein said electrochemically lithiated p or n-doped virgin single crystal Si has an upper surface containing a uniform even coating thereon of SiO₂, said even coating on said layer having a SiO₂ average thickness of between about 1.0 and 3 nm.

28. The Si anode structure defined in claim 24 wherein said electrochemically lithiated p or n-doped virgin single crystal Si has an upper surface containing a leaky coating thereon of SiO₂ said leaky SiO₂ layer having a thickness of between about 10 nm and 100 nm and passing a current of >1 mA/cm² at 1 volt.

29. The Si anode structure defined in claim 24 wherein said electrochemically lithiated p or n-doped virgin single crystal Si has a upper surface containing a porous silicon layer with a SiO₂ coating thereon, said porous silicon layer having a porosity of between about 30% and 75% and a thickness between about 1 μm and 100 μm.

30. The Si anode structure defined in claim 24 wherein said Li-containing electrode layer has a thickness of between about 50 μm and 200 μm, atop an electrolyte-soaked separator that has a combined thickness of between about 5 μm and 20 μm, atop a thin single crystal p or n-doped Si has a thickness of less than 1000 μm, atop a seed layer selected from Ti/Cu, Ti/Ni or Cr/Cu having a combined thickness of between about 20 nm and 500 nm, atop a current collector selected from Ni or Cu and having a thickness of between about 5 μm and 100 μm.

31. A lithiated Si anode structure suitable for use in a Li-ion battery comprising a Li-containing surface layer having a thickness of between about 20 nm and 50 μm atop an electrodeposited mixture of Li and Li reacted Si, that has a thickness of between about 10 μm and 50 μm, atop a thin single crystal p or n-doped, has a thickness of between about 50 μm and 1000 μm, atop a seed layer selected from Ti/Cu, Ti/Ni or Cr/Cu having a combined thickness of between about 20 nm and 500 nm, atop a current collector selected from Ni or Cu and having a thickness of between about 5 μm and 100 μm, said structure having a high load capacity of greater than 20 mg/cm² and a low capacity fade of less than 0.05% per cycle during first 100 cycles at a charge rate of C/10 or less.

32. The lithiated Si anode structure defined in claim 31 wherein said Lithium containing layer is pure Li or LiₓSi_{y} compounds.

33. The lithiated Si anode structure defined in claim 32 wherein said electrolytes are in a solid or liquid state.

34. The lithiated Si anode structure defined in claim 34 wherein said electrolyte is in solid state selected from polymer electrolytes, sulfide solid electrolytes (SSEs), argyrodite electrolytes, sulfur containing electrolytes including Li₆PS₅Cl, and lithium phosphorous oxynitride (LiPON) ceramic type electrolytes, and the separator is a polyolefin selected from polyethylene and polypropylene.

35. An anode structure comprising segmented single crystal p or n-doped Si particles forming a layer upper surface devoid of, or optionally containing said SiO₂ particles, dispersed over an electrically conducting adhesive that is mixed with organic compounds selected from a non-lithium reacting materials, having a thickness between about 5 μm and 100 μm, atop a current collector having a thickness of between about 5 μm and 50 μm.

36. The anode structure defined in claim 35, wherein said Si particles are random shape and size or regular shape or size.

37. A structure adapted to form an anode suitable for use in a Li-ion battery after an electrochemical lithiation of said structure, comprising: a Li metal positive electrode layer having a thickness of between about 50 and 200 μm positioned immediately above a liquid electrolyte-soaked separator, jointly having a thickness of between about 5 μm and 25 μm, which is atop said single crystal p or n-doped particle layer, which is positioned atop a non-lithium reacting electrical conductive adhesive layer having a thickness of between about 5 μm and 100 μm atop a current connector having a thickness of between about 5 and 50 μm.

38. The anode structure suitable for use in a Li-ion battery defined in claim 35 comprising segmented single crystal p or n-doped particles forming a layer upper surface devoid of, or optionally containing said SiO₂ layer, said Si particles having been lithiated to be enveloped with a lithium coating, dispersed over an electrical conductive adhesive that is mixed with non-lithium reacting organic compounds, having a thickness between about 5 μm and 100 μm, atop a current collector having a thickness of between about 5 μm and 50 μm.

39. An electrochemical lithiation process comprising the following steps:
Cleaning a single crystal p or n-Si substrate having a doping of approximately 10¹⁹ cm⁻³, and resistivity of approximately 0.005-ohm cm) in inorganic and organic solvents;
Forming a half-cell to be used as an anode, comprising p-type single crystal Si that is doped with Boron (B) or n-type single crystal Si that is doped with Phosphorous (P) or Arsenic (As) at concentrations greater than 10¹⁸ cm⁻³, and a resistivity of less than 0.01 Ohm·cm, said anode in said half-cell optionally has no SiO₂ surface oxide layer, or has an uneven, uniform or leaky surface SiO₂ layers;
said Li metal positive electrode layer having a thickness of between about 50 μm and 200 μm is positioned above a liquid electrolyte-soaked separator, having a thickness of between about 5 μm and 25 μm which is positioned atop said single crystal p or n-doped Si as the cathode serving as a negative electrode in a half-cell structure having a thickness of less than 1000 μm atop a current connector having a thickness of between about 5 μm and 25 μm, thus forming a Li-ion half-cell product;
Performing a lithiation process on said Li-ion half-cell product by applying a constant current in the range of between about 1 and 10 mA/cm² to obtain Li deposition on said Si surface;
Fabricating a coin cell or a pouch cell with the lithiated Si anode.

40. An electrochemical lithiation process comprising the following steps:
Cleaning a single crystal p-Si substrate having a doping of approximately 10¹⁹ cm⁻³, and resistivity of approximately 0.005-ohm cm. Perform electrochemical anodic etching of substrate in a 40% to 50% HF, with or without a surfactant to form a porous-Si region at a surface thereof;
Forming a half-cell to be used as a porous Si anode, comprising p-type Si that is doped with Boron (B) at concentrations greater than 10¹⁸ cm⁻³, and a resistivity of less than 0.01 Ohm cm. said half-cell optionally having a porous silicon surface layer,
Positioning a Li metal positive electrode layer having a thickness of between about 50 μm and 200 μm above a layer comprising a liquid electrolyte-soaked separator, having a thickness of between about 5 μm and 20 μm which is positioned atop said single crystal p or n-doped Si as a cathode serving as a negative electrode, having a thickness of less than 1000 μm atop a current connector having a thickness of between about 5 μm and 25 μm, thus forming a Li-ion half-cell product;
Applying a constant current in the range of between about 1 and 10 mA/cm² to obtain Li deposition on said Si surface to affect a lithiation process on said Li-ion half-cell product;
Fabricating a coin cell or a pouch cell with the lithiated Si as an anode.

41. The method of thin single crystal Si suitable for a Si-anode for a lithium-ion battery
Obtaining a virgin single crystal n or p-Si having a thickness between about 380 μm and 1000 μm to form a structure;
Chemically thinning said structure by immersing it in a mixture of HNO₃+HF+CH₃COOH (10:2:5 vol.) to 25-100 μm;
Oxidizing said thinned Si in HNO₃ at 90° C. for 10 minutes;
Depositing a Ti/Cu, Ti/Ni or Cr/Cu seed layer having a combined thickness of about 20 nm to 500 nm on the back surface of the Si using a standard sputtering method in an Ar plasma; electroplating said Cu on the seed layer to a thickness greater than 5 μm.
Performing electrochemical lithiation as described in claim 40.

42. A method of making a structure suitable for use in a Li-ion battery defined in claim 41 comprising:
Obtaining said virgin single crystal n or p-Si having a thickness of 380-750 μm;
Depositing a Ti/Cu, Ti/Ni or Cr/Cu seed layer of 10-30 nm followed by Cu deposition of 200-500 nm on the back of said Si using a standard sputtering method in an Ar plasma;
Electroplating said Cu to a thickness of >10 μm;
Chemically thinning said Si using a mixture of HNO₃+HF+CH₃COOH (10:2:5 vol.) to 25-100 μm while keeping a back surface with electroplated Cu protected from said mixture of HNO₃+HF+CH₃COOH;
Oxidizing said thinned Si in H₂O₂ at 65° C. for 10 minutes.
